(19) United States
(12) Patent Application Publication
(10) Pub. No.: US 2004/0203632 A1
(43) Pub. Date: Oct. 14, 2004

(54) Mobile telephone answer delay system

(75) Inventor: Thomas Matthew Schaaf, Wheaton, IL (US)

Correspondence Address: PATTON BOGGS, 1660 LINCOLN ST, SUITE 2050, DENVER, CO, 80264, US

(73) Assignee: Lucent Technologies Inc.

(21) Appl. No.: 10/109,026

(22) Filed: Mar. 28, 2002

(51) Int. Cl. H04M 11/00

(52) U.S. Cl. 455/414.1; 455/407

(57) ABSTRACT

The mobile telephone answer delay system enables a subscriber to momentarily delay receipt of an incoming call. The mobile telephone answer delay system places an incoming call on hold and provides the calling party with a prerecorded announcement in response to the mobile telephone subscriber inputting a first predetermined code in response to an incoming call indication. The recorded announcement indicates to the calling party that the subscriber is available to take the call but is momentarily unable to answer the call and will pick up shortly. The recorded announcement is repeated at predetermined intervals until the subscriber picks up the incoming call by inputting a second predetermined code.

### FIELD OF THE INVENTION

This invention relates to mobile communications systems and in particular to a feature that enables a subscriber to place an incoming call on hold and automatically provide a message to the calling party without having to immediately answer the call.

### Problem

It is a problem in mobile communications that the subscriber who is equipped with a mobile telephone frequently receives an incoming call at a time and/or in a location where they cannot immediately answer the incoming call. Since the mobile telephone is carried by the subscriber in the course of their daily activities, it is not uncommon for these daily activities to be incompatible with answering an incoming call on the mobile telephone. These situations include potentially dangerous conditions, such as operating a motor vehicle, or socially inappropriate conditions, such as being in a meeting or public facility, where the receipt of a telephone call would be disruptive to those in the vicinity of the subscriber. The options presently available to the subscriber are to leave the incoming call unanswered and let the call be automatically redirected to the subscriber's voice mail box or answer the incoming call in spite of the present conditions and the potential consequences resulting from answering the incoming call.

The present options available to a mobile telephone subscriber are less than optimal and it is desirable to provide the subscriber with an alternative that ensures that the incoming call is not missed by providing the subscriber with an opportunity to delay receipt of the incoming call.

### Solution

The above-described problems are solved and a technical advance achieved by the present mobile telephone answer delay system which enables a subscriber to momentarily delay receipt of an incoming call. The mobile telephone answer delay system places an incoming call on hold and provides the calling party with a prerecorded announcement in response to the mobile telephone subscriber inputting a first predetermined code in response to an incoming call indication. The recorded announcement indicates to the calling party that the subscriber is available to take the call but is momentarily unable to answer the call and will pick up shortly. The recorded announcement is repeated at predetermined intervals until the subscriber picks up the incoming call by inputting a second predetermined code. Optionally, a sequence of prerecorded announcements can be provided to the calling party at predetermined time intervals to provide messages of varying content.

### BRIEF DESCRIPTION OF THE DRAWINGS

FIG. 1 illustrates in block diagram form the present mobile telephone answer delay system and a typical environment in which it is operational; and

FIG. 2 illustrates in flow diagram form the operation of the present mobile telephone answer delay system.

### DETAILED DESCRIPTION

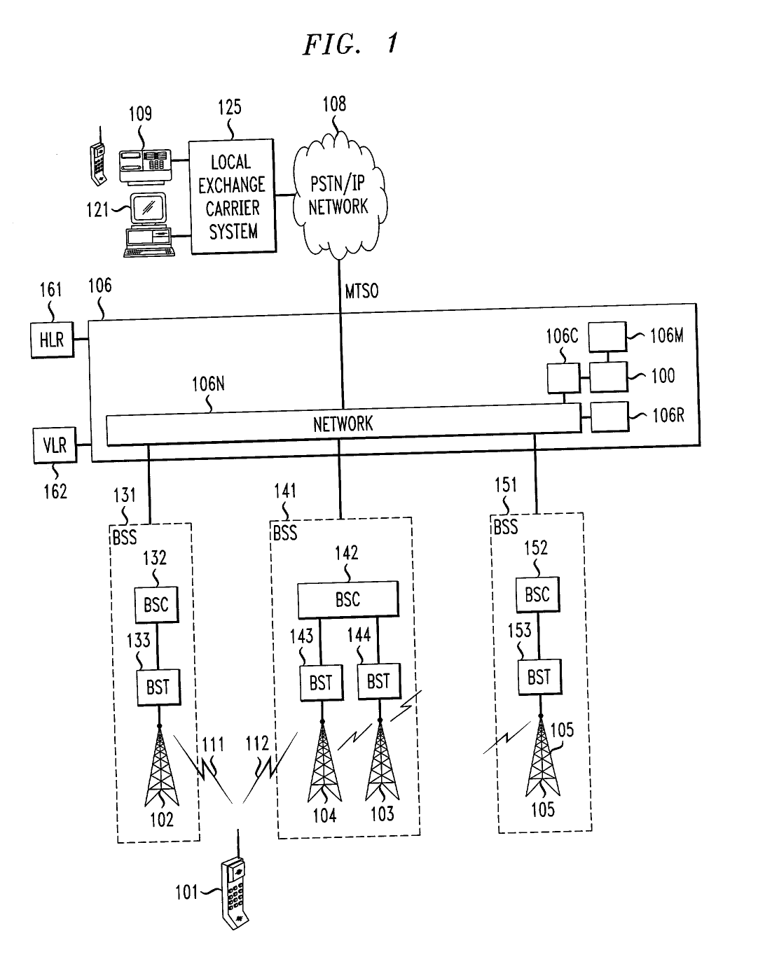

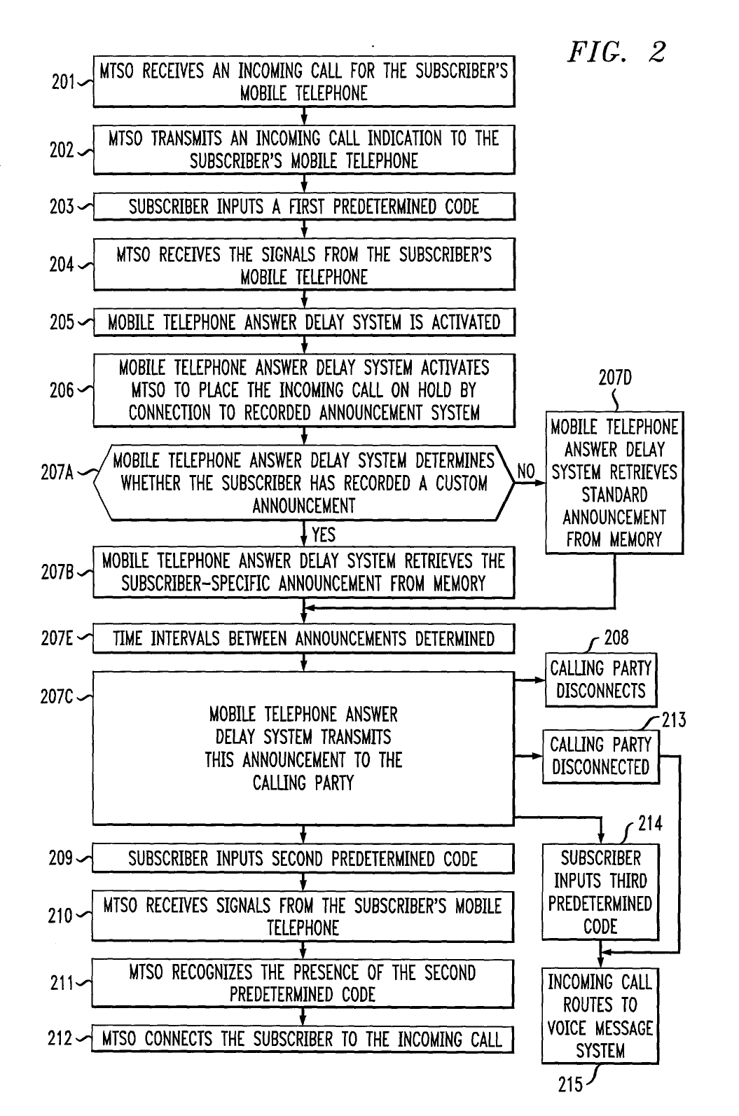

FIG. 1 illustrates in block diagram form the present mobile telephone answer delay system and a typical environment in which it is operational and FIG. 2 illustrates in flow diagram form the operation of the present mobile telephone answer delay system. The present mobile telephone answer delay system is typically implemented as a part of the mobile telephone communication system and functions to manage the routing of an incoming call in response to predetermined codes transmitted by a subscriber from their mobile telephone. In this context, the term “mobile telephone” is intended to encompass the various forms of mobile subscriber communication devices, including but not limited to: cellular telephones, personal digital assistants, Palm Pilots, personal computers, and the like.

Cellular Communication Network Architecture

FIG. 1 is the block diagram of the architecture of the present mobile telephone answer delay system 100 and one example of an existing commercial cellular communication network in which it is implemented. The primary entities of the cellular communication network providing communication services to the wireless subscriber device 101 are the Base Station Subsystems 131-151 that are associated with the Mobile Telephone Switching Office 106. In a typical cellular communications network, there are numerous Mobile Telephone Switching Offices 106, but for the sake of simplicity only a single Mobile Telephone Switching Office is shown. The Mobile Telephone Switching Office 106 is connected to the common carrier Public Switched Telephone Network 108 which serves many Local Exchange Carrier Systems 125 (one of which is shown in FIG. 1) and their associated wire-line based telephone station sets 109, 121.

The typical implementation of an existing Mobile Telephone Switching Office 106 comprises a Mobile Telephone Switching Office Controller 106C which executes call processing associated with the Mobile Telephone Switching Office 106. The mobile telephone answer delay system 100 is typically implemented as a process that executes on the Controller 106C in conjunction with a recorded announcement system 106R, served by memory 106M. A switching network 106N provides the telephone connectivity between Base Station Subsystems 131-151 and with the recorded announcement system 106R. Base Station Subsystems 131-151 communicate with wireless subscriber device 101 using Radio Frequency (RF) channels 111 and 112, respectively. RF channels 111 and 112 convey both command messages as well as digital data, which may represent voice signals being articulated at the wireless subscriber device 101 and the far-end party. With a CDMA system, the wireless subscriber device 101 communicates with at least One Base Station Subsystem 131. In FIG. 1, the wireless subscriber device 101 is simultaneously communicating with two Base Station Subsystems 131, 141, thus constituting a soft handoff. However, a soft handoff is not limited to a maximum of two base stations. Standard EIA/TIA IS-95-B supports a soft handoff with as many as six base stations. When in a soft handoff, the base stations serving a given call must act in concert so that commands issued over RF channels 111 and 112 are consistent with each other. In order to accomplish this consistency, one of the serving base station subsystems may operate as the primary base station subsystem with respect to the other serving base station subsystems. Of course, a wireless subscriber device 101 may communicate with only a single base station subsystem if determined as sufficient by the cellular communication network.

Cellular communication networks provide a plurality of concurrently active communications in the same service area, with the number of concurrently active communication connections exceeding the number of available radio channels. This is accomplished by reusing the channels via the provision of multiple Base Station Subsystems 131-151 in the service area that is served by a single Mobile Telephone Switching Office 106. The overall service area of a Mobile Telephone Switching Office 106 is divided into a plurality of “cells”, each of which includes a Base Station Subsystem 131 and associated radio transmission tower 102. The radius of the cell is basically the distance from the base station radio transmission tower 102 to the furthest locus at which good reception between the wireless subscriber device 101 and the radio transmission tower 102 can be effected. The entire service area of a Mobile Telephone Switching Office 106 is therefore covered by a plurality of adjacent cells. There is an industry standard cell pattern in which sets of channels are reused. Within a particular cell, the surrounding cells are grouped in a circle around the first cell and the channels used in these surrounding cells differ from the channels used in the particular cell and from each of the other surrounding cells. Thus, the signals emanating from the radio transmission tower in the particular cell do not interfere with the signals emanating from the radio transmission towers located in each of the surrounding cells because they are at different radio frequencies and have different orthogonal coding. However, in the case of soft handoff, the frequencies must be the same for all cells involved in the soft or softer handoff process.

The control channels that are available in this system are used to setup the communication connections between the subscriber stations 101 and the Base Station Subsystem 131. When a call is initiated, the control channel is used to communicate between the wireless subscriber device 101 involved in the call and the local serving Base Station Subsystem 131. The control messages locate and identify the wireless subscriber device 101, determine the dialed number, and identify an available voice/data communication channel consisting of a pair of radio frequencies and orthogonal coding which is selected by the Base Station Subsystem 131 for the communication connection. The radio unit in the wireless subscriber device 101 re-tunes the transmitter-receiver equipment contained therein to use these designated radio frequencies and orthogonal coding. Once the communication connection is established, the control messages are typically transmitted to adjust transmitter power and/or to change the transmission channel when required to handoff this wireless subscriber device 101 to an adjacent cell, when the subscriber moves from the present cell to one of the adjoining cells. The transmitter power of the wireless subscriber device 101 is regulated since the magnitude of the signal received at the Base Station Subsystem 131 is a function of the subscriber station transmitter power and the distance from the Base Station Subsystem 131. Therefore, by scaling the transmitter power to correspond to the distance from the Base Station Subsystem 131, the received signal magnitude can be maintained within a predetermined range of values to ensure accurate signal reception without interfering with other transmissions in the cell.

The voice communications between wireless subscriber device 101 and other subscriber stations, such as wire-line based subscriber station 109, is effected by routing the communications received from the wireless subscriber device 101 via switching network 106N and trunks to the Public Switched Telephone Network (PSTN) 108 where the communications are routed to a Local Exchange Carrier 125 that serves wire-line based subscriber station 109. There are numerous Mobile Telephone Switching Offices 106 that are connected to the Public Switched Telephone Network (PSTN) 108 to thereby enable subscribers at both wire-line based subscriber stations and wireless subscriber devices to communicate between selected stations thereof. This architecture represents the present architecture of the wireless and wireline communication networks. The present mobile telephone answer delay system 100 is shown connected to the Mobile Telephone Switching Office 106, although this example of interconnection is subject to an implementation selected by the purveyor of communique services.

Mobile Telephone Answer Delay System Operation

In operation, the Mobile Telephone Switching Office 106 at step 201 receives an incoming call that is directed to the subscriber mobile telephone. As an example, the wire-line based subscriber station 109 originates a call connection through the Local Exchange Carrier System 125 and the Public Switched Telephone Network 108 to the Mobile Telephone Switching Office 106. At step 202, the Mobile Telephone Switching Office 106 transmits an incoming call indication to the subscriber's mobile telephone 101 over the control channel associated with a radio link 111 in Base Station Subsystem 131 that is selected to serve this call connection to the subscriber's mobile telephone 101, which causes the subscriber's mobile telephone 101 to generate a human sensible output to alert the subscriber of the presence of an incoming call. This human sensible output can be audible, tactile, visual, or combinations of these outputs. At step 203, in response to receipt of the incoming call indication, the subscriber inputs a first predetermined code via operation of the mobile telephone 101. The first predetermined code can be the operation of a predetermined sequence of button operations, such as “send”, “*” or can be a voice input in mobile telephones that have a voice activated capability. The subscriber can be presented with this option via a textual display on the mobile telephone 101. The Mobile Telephone Switching Office 106, at step 204, receives the signals from the subscriber's mobile telephone 101 over the control channel and recognizes the presence of the first predetermined code. At step 205, the mobile telephone answer delay system 100 is activated and at step 206, the mobile telephone answer delay system 100 activates the Mobile Telephone Switching Office 106 to place the incoming call on hold and at steps 207A-207D provides the calling party with a prerecorded announcement. This is accomplished by extending the above-described call connection via switching network 106N to recorded announcement system 106R.

The prerecorded announcement capability can be implemented in a number of ways. There can be a single standard prerecorded announcement that informs the calling party that the subscriber is available to answer the call but there will be a momentary delay. There can be a series of prerecorded announcements that are provided to the calling party in a predetermined sequence, and at predetermined time intervals to reinforce the initial message that the subscriber will receive the call. Optionally, the subscriber can record their own custom announcement for use by the system. Thus, at step 207A, the mobile telephone answer delay system 100 determines whether the subscriber has recorded a custom announcement and if, so, at step 207B retrieves the subscriber-specific announcement from memory 106M and transmits this announcement to the calling party at step 207C. If the standard announcement is used, processing advances from step 207A to step 207D where the standard announcement is retrieved from memory 106M and transmitted to the calling party at step 207C.

The prerecorded announcement or series of prerecorded announcements are transmitted to calling party until either the subscriber answers or the calling party disconnects at step 208 or is disconnected by the mobile telephone answer delay system 100 at step 213. In the first of these latter two cases, the calling party can disconnect from the call at step 208 by hanging up or inputting a code to the mobile telephone answer delay system 100 in response to receipt of one of the prerecorded messages that offers such an option and processing exits in routine fashion. Alternatively, the mobile telephone answer delay system 100 can maintain a predetermined threshold time which represents the maximum time that a calling party can be maintained in a hold state. Upon conclusion of this time interval, the mobile telephone answer delay system 100 can route the incoming call to a voice mail system at step 215 or can terminate the incoming call to conserve cellular communication network resources. As an option, the predetermined time can be dynamically adjusted as a function of the traffic being processed by the cellular communication network. In any case, if the calling party receives an indication that the call hold state is being terminated prior to being released from hold.

In the interim, the recorded announcement system 106R can repeat the initial recorded announcement or, at the expiration of predetermined time interval(s), sequencing step 207E can activate the recorded announcement system 106R to retrieve the next successive in a series of recorded announcements from memory 106M for transmission to the calling party, The calling party remains on hold until the subscriber retrieves the incoming call from hold by inputting a second predetermined code via operation of the mobile telephone 101 at step 209. The subscriber can be presented with this option via a textual display on the mobile telephone 101. The second predetermined code can be the operation of a predetermined sequence of button operations, such as “*”, or can be a voice input in mobile telephones that have a voice activated capability. The Mobile Telephone Switching Office 106 at step 210 receives the signals from the subscriber's mobile telephone 101 and at step 211 recognizes the presence of the second predetermined code. At step 212, the Mobile Telephone Switching Office 106 connects the subscriber to the incoming call via operation of switching network 106N and processing terminates. The subscriber can, instead of entering the second predetermined code at step 209, enter a third predetermined code at step 214 to cancel the answer delay function and route the incoming call to an alternate destination, such as voice mail at step 215. The subscriber can be presented with this option via a textual display on the mobile telephone 101.

### SUMMARY

The mobile telephone answer delay system enables a subscriber to momentarily delay receipt of an incoming call where the subscriber receives an incoming call at a time and/or in a location where they cannot immediately answer the incoming call. The use of a recorded announcement informs the calling party of the state of the call and enables the subscriber to answer the call when appropriate.

What is claimed:

1. An answer delay system for mobile telephone systems comprising:
means, responsive to a subscriber inputting a first predetermined code at their mobile subscriber device in response to receipt of an incoming call indication, for providing a calling party on said incoming call with a recorded announcement; and
means, responsive to said subscriber inputting a second predetermined code at their mobile subscriber device subsequent to inputting said first predetermined code, for connecting said mobile subscriber device to said incoming call.

2. The answer delay system of claim 1 wherein said means for providing comprises:
means for repeating said recorded announcement at predetermined time intervals.

3. The answer delay system of claim 1 wherein said means for providing comprises:
means for storing a plurality of recorded announcements; and
means for transmitting said plurality of recorded announcements to said calling party in a predetermined order and at predetermined time intervals.

4. The answer delay system of claim 3 wherein said means for storing comprises:
means, responsive to an incoming call received from said subscriber, for recording an announcement transmitted by said subscriber; and
means for presenting said announcement transmitted by said subscriber to said calling party on a subsequently received said incoming call.

5. The answer delay system of claim 1 further comprising:
means, responsive to signals received from said mobile subscriber device during receipt at said mobile subscriber device of an incoming call indication, for determining whether said received signals comprises said first predetermined code.

6. A method for providing answer delay in a mobile telephone systems comprising the steps of:
providing, in response to a subscriber inputting a first predetermined code at their mobile subscriber device in response to receipt of an incoming call indication, a calling party on said incoming call with a recorded announcement; and
connecting, in response to said subscriber inputting a second predetermined code at their mobile subscriber device subsequent to inputting said first predetermined code, said mobile subscriber device to said incoming call.

7. The method of providing answer delay of claim 1 wherein said step of providing comprises:
repeating said recorded announcement at predetermined time intervals.

8. The method of providing answer delay of claim 1 wherein said step of providing comprises:
storing a plurality of recorded announcements in a memory; and
transmitting said plurality of recorded announcements to said calling party in a predetermined order and at predetermined time intervals.

9. The method of providing answer delay of claim 8 wherein said step of storing comprises:
recording, in response to an incoming call received from said subscriber, in said memory an announcement transmitted by said subscriber; and
presenting said announcement transmitted by said subscriber to said calling party on a subsequently received said incoming call.

10. The method of providing answer delay of claim 1 further comprising the step of:
determining, in response to signals received from said mobile subscriber device during receipt at said mobile subscriber device of an incoming call indication, whether said received signals comprises said first predetermined code.

11. An answer delay system for mobile telephone systems comprising:
code determining means, responsive to signals received from said mobile subscriber device during receipt at said mobile subscriber device of an incoming call indication, for determining whether said received signals comprises a first predetermined code.
incoming call hold means, responsive to a subscriber inputting a first predetermined code at their mobile subscriber device in response to receipt of an incoming call indication, for providing a calling party on said incoming call with a recorded announcement; and
call connection means, responsive to said subscriber inputting a second predetermined code at their mobile subscriber device subsequent to inputting said first predetermined code, for connecting said mobile subscriber device to said incoming call.

12. The answer delay system of claim 11 wherein said incoming call hold means comprises:
timing means for repeating said recorded announcement at predetermined time intervals.

13. The answer delay system of claim 11 wherein said incoming call hold means comprises:
memory means for storing a plurality of recorded announcements; and
sequencing means for transmitting said plurality of recorded announcements to said calling party in a predetermined order and at predetermined time intervals.

14. The answer delay system of claim 13 wherein said memory means comprises:
recording means, responsive to an incoming call received from said subscriber, for recording an announcement transmitted by said subscriber; and
retrieval means for presenting said announcement transmitted by said subscriber to said calling party on a subsequently received said incoming call.
